(19) United States
(12) Patent Application Publication
(10) Pub. No.: US 2005/0210038 A1
(43) Pub. Date: Sep. 22, 2005

(54) Method for providing workflow functionality and tracking in an annotation subsystem

(75) Inventors: Richard D. Dettinger, Rochester, MN (US); Cale T. Rath, Byron, MN (US)

Correspondence Address: William J. McGinnis, Jr., IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/803,603

(22) Filed: Mar. 18, 2004

(51) Int. Cl. G06F 17/00

(52) U.S. Cl. 707/100

(57) ABSTRACT

Methods, systems, and articles of manufacture that may be used to gather information about processes based on the state of a related annotation are provided. Different fields of the annotation may be filled in by different users as they complete different parts of a process. As a result, the current state of the annotation may be determined by applying various state rules to the annotation, based on the data contained therein.

### CROSS-REFERENCE TO RELATED APPLICATIONS

The present application is related to commonly-owned U.S. Pat. No. 6,519,603, entitled “Method And System For Organizing An Annotation Structure And For Querying Data And Annotations” and commonly owned, co-pending application Ser. No. 10/600,014, entitled “Universal Annotation Management System”, which are herein incorporated by reference.

### BACKGROUND OF THE INVENTION

1. Field of the Invention

The present invention generally relates to annotations and, more particularly, to tracking the status of annotations based on data contained therein.

2. Description of the Related Art

In a conventional annotation system, descriptive information is stored about objects, or parts of objects, as an annotation. Some annotation systems store annotations separately, without modifying the objects themselves. An annotation store, typically a database, contains information for the annotation, typically in the form of descriptive text, or other classifiers.

An indexing scheme is typically used to map each annotation to the annotated data object or sub-object, based on identifying information, typically in the form of an index. The indexing scheme typically works both ways: given an index, the indexing scheme must be able to locate the annotated data object and, given an object, the indexing scheme must be able to calculate the index for use in classification, comparison, and searching (e.g., to search for annotations for a given data object).

Annotation data is typically entered via a graphical front end or input form allowing a user or “author” to enter in data in a number of fields. In a conventional annotation system, the annotation author may be required to enter data for all the fields before the annotation is accepted, although others users might be able to modify them at a later time. Moreover, as described above, this annotation data typically describes a particular data object or set of data objects.

There are times when a group of users would like to use an annotation system to collect information about various steps of a process on which the users are collaborating. Ideally, each user could access a common annotation and update one or more fields therein to provide input, for example, regarding a portion of the process for which they are responsible. The information stored in such an annotation might provide valuable information regarding the process (e.g., which steps have been performed and by whom). However, as previously described, current annotation systems typically associate annotations with particular data objects and require each field to be entered (e.g., by an annotation author or subsequent viewer) and, thus, do not readily allow for the collection of information regarding processes involving multiple users.

Accordingly, there is a need for an annotation system that allows the status of annotations to be tracked based on the data contained therein.

### SUMMARY OF THE INVENTION

The present invention generally is directed to a method, system and article of manufacture for tracking the status of annotations.

One embodiment provides a method for tracking the status of a annotations. The method generally includes creating an annotation record comprising one or more fields for storing data related to the process, retrieving annotation data related to the process stored in the annotation record, and applying a set of state rules to determine a first state of the process based on the annotation data.

Another embodiment provides a method for managing annotations having multiple states. The method generally includes defining a plurality of annotation types, each annotation type having one or more associated fields, defining a set of state rules for each annotation type, wherein each state rule identifies an annotation state based on annotation data in the one or more fields associated with its corresponding annotation type, and providing a state machine capable of retrieving annotation data for an annotation of one of the defined annotation types, applying the state rules for that type to the annotation data to determine the state of the annotation, and providing an indication of the annotation state.

Another embodiment provides a method for tracking the status of a annotations. The method generally includes providing an annotation form for receiving annotation data in a plurality of fields related to the processes, storing annotation data received via the annotation form in a plurality of annotation records, wherein each annotation record corresponds to one of the similar type processes, providing a set of state rules defining a plurality of states for the process type based on annotation data in each record, applying the state rules to the annotation data in each record to determine the state of each process, and generating a report indicating the state of each process.

Another embodiment provides a a computer-readable medium containing a program for managing annotations having multiple states. When executed by a processor, the program performs operations generally including creating an annotation record comprising one or more fields for storing data related to the process, retrieving annotation data related to the process stored in the annotation record, and applying a set of state rules to determine a first state of the process based on the annotation data.

Another embodiment provides an annotation system generally including one or more annotation structures, each identifying one or more annotation fields associated with an annotation type, an annotation store for storing annotation records, each having fields associated with one of the annotation types, a set of state rules for each annotation type, and a state machine. Each set of state rules defines a plurality of states for each associated annotation type based on the annotation data in the one or more associated fields. The state machine is generally configured to access an annotation record from the annotation store and apply the set of state rules for the corresponding annotation type to determine an annotation state based on the date stored therein.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with embodiments of the present invention.

FIG. 2 is a relational view of software components according to one embodiment of the present invention.

FIG. 3 is a flow chart illustrating exemplary operations for tracking the status of annotations according to one embodiment of the present invention.

FIG. 4 illustrates different states of an annotation according to one embodiment of the present invention.

FIGS. 5A-5D illustrated exemplary GUI screens according to one embodiment of the present invention.

FIG. 6 is a flow chart illustrating exemplary operations for tracking the status of multiple annotations according to one embodiment of the present invention.

FIG. 7 illustrates an exemplary table listing the states of a plurality of annotations.

### DETAILED DESCRIPTION OF THE PREFERRED EMBODIMENTS

The present invention provides methods, systems, and articles of manufacture that may be used to track the state of annotations. For some embodiments, different fields of the annotation may be filled in by different users, for example, as they complete different tasks of a process. As a result, a current state of the annotation may be determined by applying various state rules to the annotation. The state rules may define different states of the annotation, for example, based on what fields are (or are not) filled in and, possibly, the actual content of those fields.

As used herein, the term annotation generally refers to any type of descriptive information captured about an entity (e.g., a data object) or, in the examples described here, processes. Annotations may exist in various forms, including textual annotations (descriptions, revisions, clarifications, comments, instructions, etc.), graphical annotations (pictures, symbols, etc.), sound clips, etc. While an annotation may exist in any or all of these forms, to facilitate understanding, embodiments of the present invention may be described below with reference to annotations containing text fields as particular, but not limiting, examples of annotations. Accordingly, it should be understood that the following techniques described with reference to textual annotations may also be applied to other types of annotations, as well, and, more generally, to any type of reference to a process.

As used herein, the terms process, workflow and process workflow may be used interchangeably and each generally refer to any series of one or more actions or operations conducing to an end. The actions or operations are generally performed by one or more users. As used herein, the term user generally applies to any entity capable of performing an action, such as a person (e.g., an individual) interacting with an application program or an application program itself, for example, performing automated tasks (e.g., automatically filling in fields of an annotation). While the following description may often refer to a graphical user interface (GUI) intended to present information to and receive information from a person, it should be understood that in many cases, the same functionality may be provided through a non-graphical user interface, such as a command line and, further, similar information may be exchanged with a non-person user via an application programming interface.

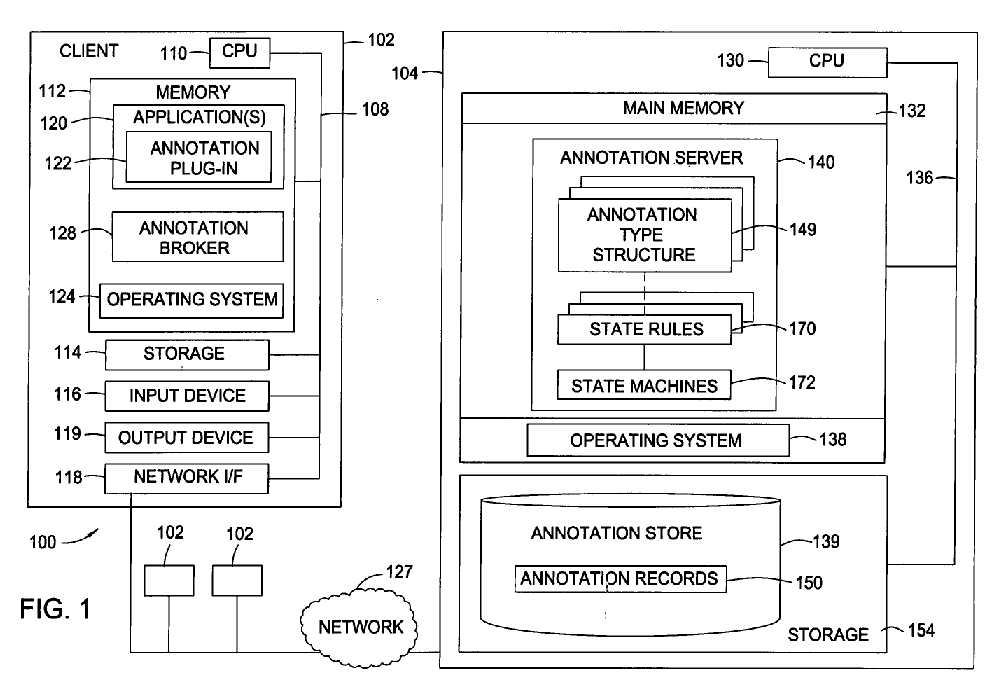

One embodiment of the invention is implemented as a program product for use with a computer system such as, for example, the network system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Environment

FIG. 1 illustrates a client-server view of an exemplary network system 100 in which an annotation system in accordance with the present invention may be utilized to exchange information, captured in the form of annotations, between users collaborating on a process. For some embodiments, various components of the annotation system utilized in the system 100 may be similar in operation to those of the annotation system described in the commonly owned, co-pending application Ser. No. 10/600,014, entitled “Universal Annotation Management System,” and incorporated herein by reference.

As illustrated, the system 100 generally includes one or more client computers 102 (e.g., user workstations) and at least one server computer 104. The client computers 102 and server computer 104 may be connected via a network 127. In general, the network 127 may be any combination of a local area network (LAN), a wide area network (WAN), wireless network, or any other suitable type network, including the Internet.

As illustrated, the client computers 102 generally include a Central Processing Unit (CPU) 110 connected via a bus 108 to a memory 112, storage 114, input devices 116, output devices 119, and a network interface device 118. The input devices 116 may be any devices to give input to the client computer 102, such as a mouse, keyboard, keypad, light-pen, touch-screen, track-ball, or speech recognition unit, audio/video player, and the like. The output devices 119 may be any suitable devices to give output to the user, including speakers and any of various types of display screen. Although shown separately from the input device 116, the output device 119 and input device 116 could be combined (e.g., a display screen with an integrated touch-screen.

The network interface device 118 may be any entry/exit device configured to allow network communications between the client computer 102 and the server computer 104 via the network 127. For example, the network interface device 118 may be a network adapter or other network interface card (NIC). Storage 114 is preferably a Direct Access Storage Device (DASD). Although shown as a single unit, storage 114 may be any combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory (RAM) sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips. Illustratively, the memory 112 contains an operating system 124. Examples of suitable operating systems, which may be used to advantage, include Linux and Microsoft's Windows®, as well as any operating systems designed for handheld devices, such as Palm OS®, Windows® CE, and the like. More generally, any operating system supporting the functions disclosed herein may be used.

The memory 112 is also shown containing at least one application 120. Some application programs 120 may be configured to communicate with the annotation server 140 directly, for example, via a set of application programming interface (API) functions (not shown) provided for the annotation server 140. As used herein, the term API generally refers to any set of interface functions (e.g., implementing any suitable inter-process protocol) that may be used to communicate between a client computer or process and a server computer or process. Other application programs, however, may communicate with the annotation server 140 via plug-in components 122 and/or the annotation broker 128 (e.g. also via API functions). In other words, annotation capability may be added to an existing application 120 via the plug-in components 122. The plug-in components 122 may, for example, present graphical user interface (GUI) screens to users of applications 120, thus allowing the creation and retrieval of annotations from within the applications used to manipulate the annotated data.

The annotation broker 128 is an optional component and may be implemented as a software component configured to present a standard interface to the annotation server 140 from various applications 120, for example, communicating with plug-in components 122 from multiple applications running on the same client computer 102. Hence, the annotation broker 128 may provide a degree of separation between the applications 120 and the annotation server 140, hiding detailed operation of the annotation server 140 and facilitating development of plug-in components 122. In other words, new applications 120 may be supported through the development of plug-in components 122 written in accordance with the annotation broker interface.

Components of the server computer 104 may be physically arranged in a manner similar to those of the client computer 102. For example, the server computer 104 is shown generally comprising a CPU 135, a memory 132, and some type of storage system, such as a database management system (DBMS) 154, coupled to one another by a bus 136, which may all functions as similar components described with reference to the client computer 102. The server computer 104 is generally under the control of an operating system 138 (e.g., IBM OS/400®, UNIX, Microsoft Windows®, and the like) shown residing in memory 132. As illustrated, for some embodiments, the server computer 104 may be configured with a content management system 170, such as IBM's Content Manager, generally configured to manage documents 117.

As illustrated, the server computer 104 may also be configured with the annotation server 140, also shown residing in memory 132. The annotation server 140 provides annotation clients (e.g., running on one or more client computers 102) with access to the annotation store 139, for example, via annotation API functions. In other words, the annotation API functions generally define the interface between annotation clients and the annotation server 140. As used herein, the term annotation client generally refers to any user interface (or other type front-end logic) of the annotation system that communicates with the annotation server to manipulate (e.g., create, update, read and query) annotation data. Examples of annotation clients include applications 120 communicating with the annotation server 140 (directly, or via plug-in components 122) or an external application, such as an annotation browser (not shown).

The annotation server 140 may be configured to perform a variety of operations, such as responding to requests to create annotations for specified data objects, formulating and issuing queries against the annotation store 139 to search for annotations for a specified data object, and formulating and issuing queries against the annotation store 139 to search for annotations satisfying one or more specified conditions (e.g., having a specified author, creation date, content, and the like). The annotations may be contained in annotation records 150, for example, stored in an annotation database 139.

### Annotation Types and States

For other embodiments, the data captured as annotations may be organized as a set of fields defined in an annotation structure 149. Thus, each annotation structure may, in effect, define a different type of annotation. As an example (discussed in further detail below), a “problem tracking” annotation type may include text fields for identifying a problem, proposing a solution, and requesting information, as well as other fields for indicating whether/when the solution has been approved.

The creation and use of such annotation structures is described in detail in the previously referenced co-pending application Ser. No. 10/600,014, entitled “Universal Annotation Management System.” As described therein, for some embodiments, certain annotation structures may be associated with users operating in a certain type of role, thus allowing different users to create different types of annotations and/or only modify or view certain fields. For example, continuing with the problem tracking example, only quality assurance personnel may be authorized to propose a solution to a problem, while only a manager may be authorized to approve a proposed solution.

As illustrated, the annotation server 140 may have an associated state machine 172 which may be configured to determine the state of an annotation based on the contents of the annotation data contained therein. For example, each different annotation type (defined by a structure 149) may have a corresponding set of state rules. To determine the state of an annotation, the state machine may select the state rules 170 for the corresponding annotation type and apply them to the current set of annotation data (e.g., stored in an annotation record 150).

Each state rule may be a combinations of one or more logical statements that examine the contents of one or more of the fields. For example, a “new problem” state for an annotation may be defined as the annotation having text in the problem field, but not in the solution field, expressed (in pseudocode) as:
IF PROBLEM_FIELD!=NULL
AND SOLUTION_FIELD=NULL
THEN STATE=NEW_PROBLEM.
   Similarly, a “pending approval” state may be defined as the annotation having text in the problem field, text in the proposed solution field, but no entry in an approval field (e.g., a checkbox or initial field indicating a manager's approval). Each state rule may be a combinations of one or more logical statements that examine the contents of one or more of the fields.

For some embodiments, more complex rules (than those based solely on the existence or absence of data) may also be created, for example, that define a state of an annotation based on the presence of specified strings in a text field. Using such rules, the text of annotations may be automatically scanned for key words and annotation state updated accordingly. This may be useful in several applications, such as tracking patient conditions, diagnoses, or treatment in a medical environment. For example, in some cases states may be defined for certain medical conditions that may be detected by the presence of related terms in a “diagnosis” field. In response to detecting the related terms in the text (and the associated state), a specialist may be automatically informed. The specialist may then access the annotation, review the information and recommend a treatment (text in a treatment field may indicate a “treatment recommended” state), which may, in turn cause a facility administering the treatment to be notified.

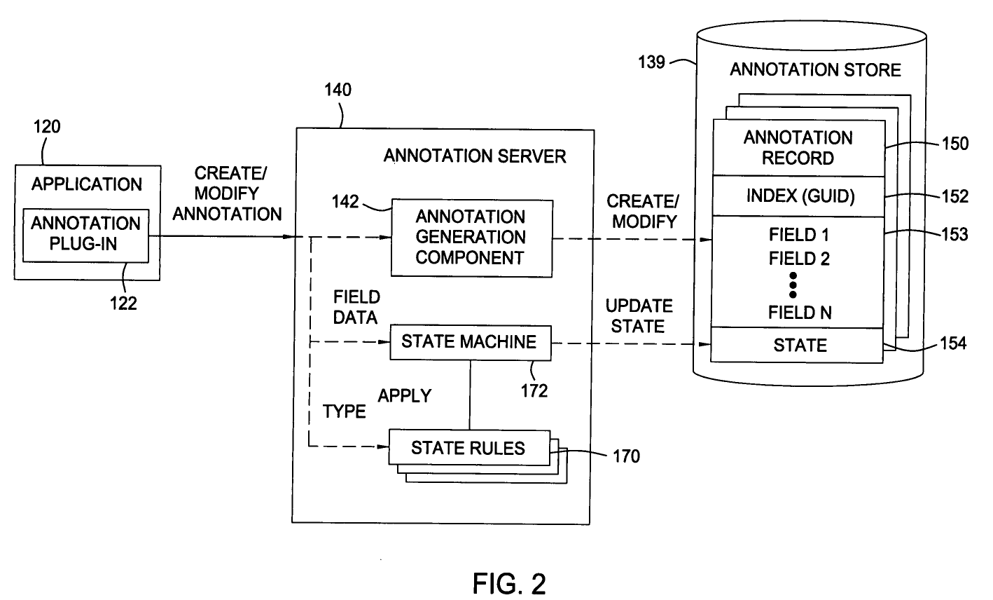

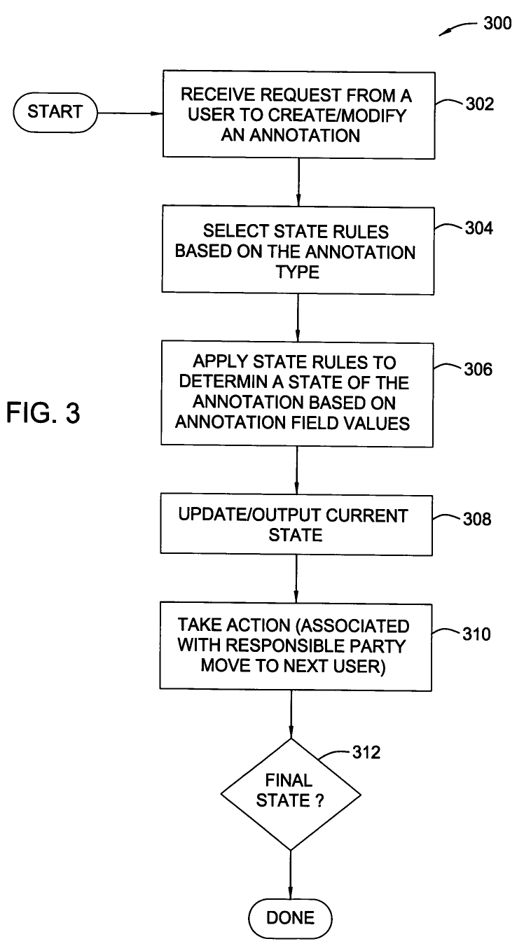

FIG. 2 is a relational view of software components, according to one embodiment of the present invention, that illustrates how the state machine 172 may determine the state of an annotation based on the state rules 172. The software components illustrated in FIG. 2 may be described with simultaneous reference to FIG. 3 which is a flow diagram of exemplary operations 300 that may be performed thereby.

The operations 300 begin, at step 302, by receiving a request to create or modify an annotation. As shown, the annotation server 140 may include an annotation generation component 142 allowing an annotation to be created or modified from an application 120 (e.g., via an annotation plug-in 122). As illustrated, the annotation generation component 142 may fill in or modify fields in an annotation record 150. As previously described, the exact fields contained in the annotation record 150 may be determined by the type of annotation and may be defined in a corresponding structure.

At step 304, state rules 170 defining the various states of the annotation are selected (e.g., by the state machine 172), for example, based on the type of the annotation. For some embodiments, the type of annotation may be indicated, for example, by a global unique identifier (GUID) 152 of the annotation. For other embodiments, an annotation type may be stored as a separate field.

At step 306, the selected state rules are applied to determine a state of the annotation based on the annotation field values. For example, the state machine 172 may query the annotation store to retrieve the field values and apply the state rules accordingly. At step 308, a current state of the annotation is updated or output.

For some embodiments, the annotation state may be an actual field 154 maintained in the annotation record 150, which may be updated by the state machine 172, for example, anytime the query is modified. In such embodiments, the current state of an annotation may be simply read from the annotation store 130. For other embodiments, however, no specific state field 154 is maintained. In such embodiments, the state machine 172 may be required to retrieve the annotation data and apply the state rules 170 to determine the current annotation state (e.g., each time it is requested by a user).

At step 310, an action is (optionally) taken based on the current state of the annotation. As an example, in some cases, different users responsible for filling out different portions of an annotation form required to cause the annotation to change from one state to the next may be notified (e.g., via an e-mail or some other type of messaging) that their input is required. As another example, various users interested in the state of the annotation (e.g., whether a solution has been proposed, a proposal approved or implemented, etc.) may be automatically notified of any or only certain state changes. As described in greater detail below, for some embodiments, additional processes may also be initiated based on the state of one or more annotations.

If the annotation has reached its final state, as determined at step 312, the operations may terminate. Otherwise, the operations may return to step 302, to await another change to the annotation, such as additional input for one of the fields required to transition the annotation to the next state. Accordingly, these operations may continue to be repeated iteratively as the annotation is modified and changes states as the annotation, in effect, serves as an input form “traveling” among different users responsible for providing annotation data at different states.

### A Traveling Annotation Form

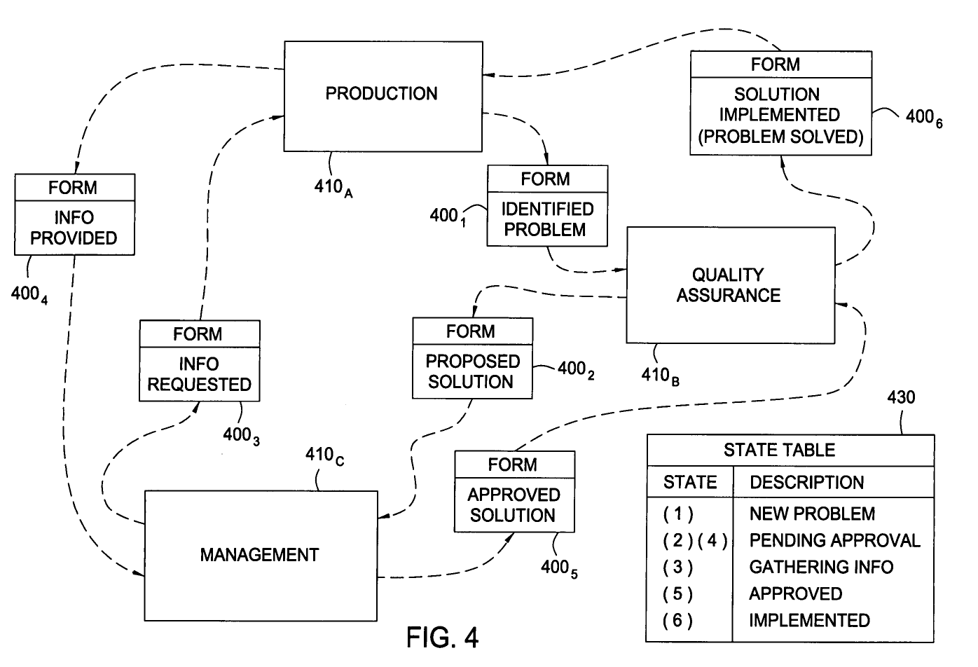

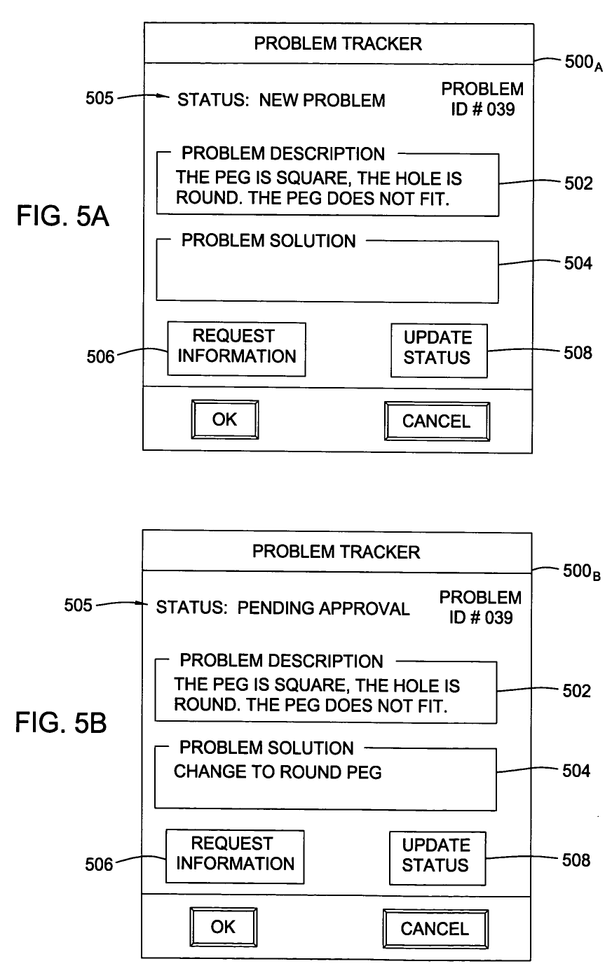

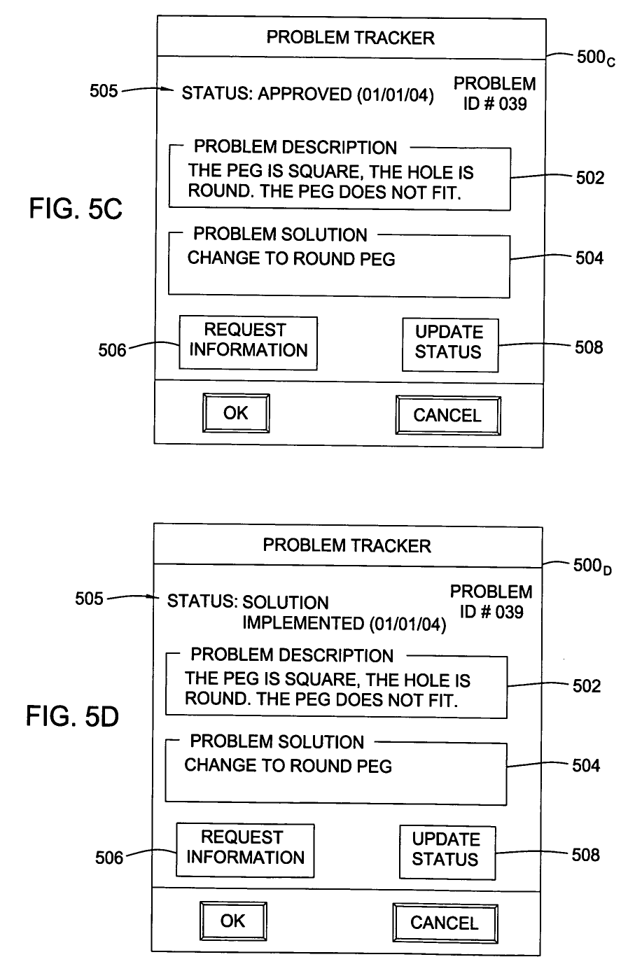

FIG. 4 illustrates how an exemplary “problem tracking” annotation 400 changes state as it travels among different users, illustratively represented as personnel of different departments 410. Subscripts are used to indicate different states of the annotation that are also listed in a state table 430. FIGS. 5A-5D illustrated exemplary GUI screens 500 of the corresponding annotation input form, at various annotation states.

The annotation 400₁ represents the annotation 400 in a “new problem” state, for example, after personnel from a production department 410_{A} generates the annotation 400 specifying a new problem. As illustrated in the GUI screen 500_{A} of FIG. 5A, the new problem may be specified by filling in text in a problem description field 502. Thus, as previously described, the new problem state may be defined by the existence of text in the new problem field 502 and not in any other fields. As shown, a current status of the annotation may be shown in a status field 505.

As illustrated in FIG. 4, the annotation may travel to personnel (e.g., a user) in a quality assurance (QA) department 410_{B} in the new problem state (400₁). The annotation may stay in the new problem state until the QA personnel proposes a solution, for example, by entering text in the proposed solution field 504. The entry of text in the proposed solution field 504 (FIG. 5B) may result in a transition to a “pending approval” state of the annotation (400₂), which may then travel to personnel in a management department 410_{C} for approval.

As illustrated, from the GUI screens 500, users may be able to request more information via a button 506 which may, for example, be used to access another GUI screen (not shown) allowing a user (e.g., management or QA personnel) to indicate the requested information. As an example, prior to approving a proposed solution, a manager may request more information about the problem from production personnel. As a result, the annotation may travel back to the production personnel in a “gather information” state (400₃). Once the personnel provides the information, the annotation may be returned to management in a “information provided” state (400₄).

Once satisfied, the manager may approve the proposed solution, for example, by accessing an approval screen (e.g., via an update status button 508) in which the manager may fill in a field indicating approval (e.g., by initialing or checking an approval box). The approval (and date) may be noted in the status field 505, as shown in FIG. 5C. Once approved, the annotation may travel back to the QA department 410_{B} in an approved state (400₅), for example, notifying the QA personnel they are authorized to implement a solution.

Once a solution is implemented, the QA personnel may update the status of the annotation (e.g., again via the update status button 508) to indicate such, which may be reflected in the status field 505, as shown in FIG. 5D. The annotation may then travel back to the production personnel in a “solution implemented” state (400₆), notifying the production personnel the problem has been solved and how. The solution implemented state may represent a final state of the annotation, requiring no additional information. Alternatively, additional states could be defined, for example, to track how well the implemented solution actually solves the problem.

Of course, the problem tracking example described above is illustrative of just one type of application in which an annotation having multiple states may be used to gather information about a process workflow involving multiple users. Information about a wide variety of different type process workflows may also be tracked using different types of annotations with multiple states.

As an example, in a teaching hospital, a medical student or resident physician may see and diagnose a patient. Their diagnosis may be entered as an annotation that must, in turn, be reviewed by the overseeing physician prior to its acceptance. Once accepted, the annotation (containing the approved diagnosis) may move to the next stage in the process, for example, to receive input on treatment (based on the diagnosis) from a specialist who may be located at the same facility or some other facility around the world. Once the specialist recommends treatment, the annotation may travel back to doctors at the teaching hospital or wherever actual treatment may be performed.

As another example, a lab technician may decide to write an annotation on some type of gene structure (e.g., a microarray) stating that he had found an expressed region that may potentially be the cause of a disease. Before this annotation is made available to other researches, indicating it is truly the cause of the disease, the annotation may first be investigated by the lab technician's peers and mentors and up the hierarchy before it could be approved.

### Gathering Information about Processes

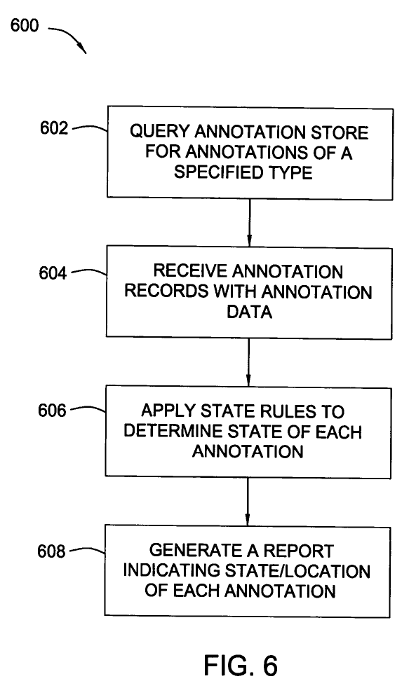

In some embodiments, by associating different states with annotations, valuable information about various processes may be gathered automatically without disrupting those processes. FIG. 6 illustrates exemplary operations 600 that may be performed to automatically track a process based on the corresponding annotation states, as indicated by the presence (or the lack of) particular data contained therein. At step 602, the annotation store is queried to retrieve annotation records of a given type (corresponding to the process being tracked). At step 604, the annotation records with the corresponding annotation data are received. At step 606, the state rules are applied to determine the state of each annotation retrieved. At step 608, a report is generated indicating the state/location of each annotation.

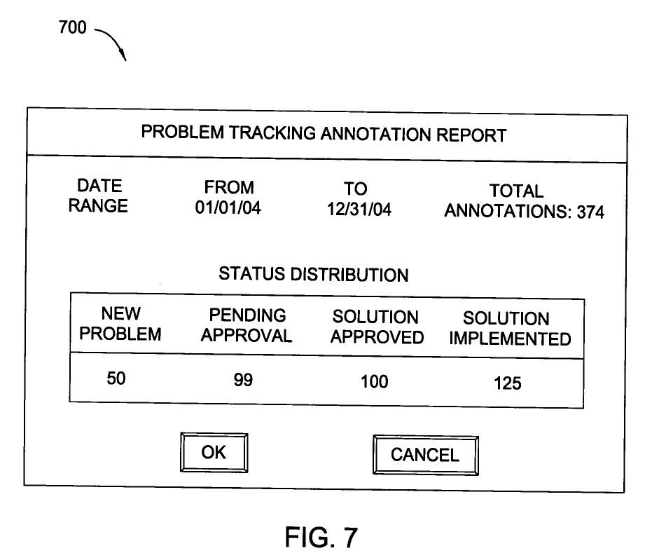

The type of report generated may depend on the type of process being investigated and what type of information about the process is sought. For example, to investigate the efficiency of the problem solving process illustrated in FIG. 4, the annotation store may be queried to determine the state of each “problem tracking” annotation. FIG. 7 illustrates an exemplary report 700 that may be generated showing the relative number of each state for the problem tracking annotations. The relative number of annotations in each state may identify bottlenecks in the problem tracking process. In other words, a large number of annotations in the “new problem” state (with no proposed solution) may indicate a bottleneck in the QA department. Similarly, a large number of annotations in the “pending approval” state may indicate a bottleneck in management.

Another example that illustrates how annotations may be used to track existing company processes without disrupting those processes involves customer order and shipment tracking. For example, a company may have an existing process in which a sales representative takes a customer order over the phone, fills the order and ships it out, and follows up at a later date with a call to ensure the customer received the order and is satisfied. This existing process could be augmented by creating a new annotation on the transaction record with various states related to the process.

For example, upon creation, the annotation may include a shipment tracking number as a field, which puts the order into a “shipped” state (which could be preceded by an “order pending state”). Application of a state rule that compares the expected arrival date with the current date could change the state to a “verify” state which may cause the annotation to be routed to an assistant, prompting them to verify the order was received (based on the tracking number contained therein). After verifying the order was received, this assistant may fill in the delivery date which puts the annotation in a “follow-up” state and routes it back to the sales representative to contact the customer to ensure satisfaction/any other needs are met. Any order that was not received could be noted, placing the annotation in an “investigate non-delivery” state, for example, prompting a representative to contact the shipping company.

A report similar to that shown in FIG. 7 could be generated by querying the annotation store and determining the state of each such “order tracking” annotation, for example, providing insight into bottlenecks related to the shipping process. While the exact states described above are exemplary only, this example illustrates how annotations may be used to track existing processes in an entity without disruption of those processes (e.g., existing databases may be maintained). By properly defining the state rules based on the existing process, the annotation system ties people together by routing the annotations to those users that are responsible for performing an action that places the annotation in the next state at any given time.

### Automated Processing based on Annotation States

As previously described, a change in annotation state may automatically initiate an action, such as notifying a user, in effect, routing the annotation to that user. For some embodiments, a change in annotation state may automatically initiate a process, for example, that examines or modifies the annotation data itself and may even automatically initiate yet another process as a result.

As an example, an annotation may be created that contains results of a test performed on blood samples from a number of patients. The results may be obtained from some equipment by a lab technician and may need to be verified, for example, by a manager. If the results fall outside of an expected range, the manager may note that in some field on the annotation, placing the annotation in an “unverified” state, which may initiate a process designed to detect problems obtaining good test results. For example, this process may examine how many other annotations are also in the unverified state. The number of annotations in the unverified state may be determined by querying the annotation store. As an alternative, some processes may automatically maintain a counter that is incremented every time an annotation reaches the unverified state and updates a field in that annotation.

In any case, too many annotations in the unverified state may indicate a problem, for example, with the equipment used to obtain the test results. Therefore, number of annotations in the unverified state (or a percentage of total annotations in the unverified state) may be compared against a threshold value which, if exceeded, may indicate a problem. If the number of annotations in the unverified state exceeds the threshold value, this process may automatically perform some appropriate action, such as notifying maintenance personnel for the lab that the equipment may require calibration.

### CONCLUSION

By supporting multiple states of an annotation, valuable information regarding a related process may be automatically gathered without disrupting that process. Different annotation types may be defined to allow the status of different type processes to be tracked. A set of state rules may define the various annotation states, based on the content of data in fields associated with each annotation type. By examining the states of a group of annotations, insight into the workings of the process may be obtained. In some cases, a change in state may trigger a process that automatically examines or modifies the annotation data and/or triggers another process.

While the foregoing is directed to embodiments of the present invention, other and further embodiments of the invention may be devised without departing from the basic scope thereof, and the scope thereof is determined by the claims that follow.

1. A method for tracking the status of an annotation, comprising:
creating an annotation record comprising one or more fields for storing annotation data;
retrieving annotation data stored in the annotation record; and
applying a set of state rules to determine a first state of the annotation based on the annotation data.

2. The method of claim 1, further comprising:
receiving additional annotation data;
updating the annotation record with the additional annotation data; and
applying the set of state rules to determine a second state of the annotation based on the annotation data in the updated annotation record.

3. The method of claim 2, further comprising providing an indication that the state of the annotation has changed from the first state to the second state.

4. The method of claim 3, wherein providing the indication that the state of the annotation has changed comprises notifying an entity.

5. The method of claim 4, wherein notifying the entity comprises notifying an entity responsible for providing annotation data required to change the state of the annotation from the second state to a third state.

6. The method of claim 1, wherein:
the annotation record is associated with a particular annotation type; and
the method further comprises retrieving the state rules based on a type of the annotation.

7. The method of claim 6, wherein the method further comprises:
generating an interface screen based on an annotation structure associated with the annotation type, wherein the annotation structure identifies the one or more fields; and
receiving annotation data via the interface.

8. The method of claim 1, wherein the annotation record comprises a field indicating the current state of the annotation.

9. The method of claim 1, further comprising initiating a process in response to detecting a change in the annotation state.

10. The method of claim 9, wherein the process examines a number of annotations in the same annotation state.

11. The method of claim 9, wherein the process modifies the annotation data.

12. The method of claim 9, wherein the process initiates another process.

13. A method for managing annotations having multiple states, comprising:
defining a plurality of annotation types, each annotation type having one or more associated fields;
defining a set of state rules for each annotation type, wherein each state rule identifies an annotation state based on annotation data in the one or more fields associated with its corresponding annotation type; and
providing a state machine capable of retrieving annotation data for an annotation of one of the defined annotation types, applying the state rules for that type to the annotation data to determine the state of the annotation, and providing an indication of the annotation state.

14. The method of claim 13, wherein at least one of the state rules for at least one of the annotation types identifies a state based on the presence or absence of data in at least one of the fields associated with that annotation type.

15. The method of claim 14, wherein at least one of the state rules for at least one of the annotation types identifies a state based on the presence or absence of data in at least two of the fields associated with that type.

16. The method of claim 13, wherein at least one of the state rules for at least one of the annotation types identifies a state based on a specified string of text in one of the fields associated with that type.

17. The method of claim 13, further comprising:
providing annotation structures for each annotation type, wherein each annotation structure identifies the one or more fields for a corresponding annotation type; and
generating annotation forms, based on the annotation structures, for receiving annotation data for each annotation type.

18. A method for gathering information about a plurality of processes of a similar process type, comprising:
providing an annotation form for receiving annotation data in a plurality of fields related to the processes;
storing annotation data received via the annotation form in a plurality of annotation records, wherein each annotation record relates to one of the similar type processes;
providing a set of state rules defining a plurality of states for the annotation based on the annotation data in each record;
applying the state rules to the annotation data in each record to determine the state of each annotation; and
generating a report indicating the state of each annotation.

19. The method of claim 18, wherein each annotation record comprises a field for storing the current state of the corresponding annotation.

20. The method of claim 18, wherein at least one of the state rules defines an annotation state based on presence or absence of data in one of the fields.

21. A computer-readable medium containing a program for managing annotations having multiple states which, when executed by a processor, performs operations comprising:
creating an annotation record comprising one or more fields for storing annotation data;
retrieving annotation data stored in the annotation record; and
applying a set of state rules to determine a first state of the annotation based on the annotation data.

22. The computer-readable medium of claim 21, wherein the operations further comprise providing an indication of the first state of the annotation in an interface screen displaying the annotation data.

23. The computer-readable medium of claim 21, wherein the operations further comprise
receiving additional annotation data;
updating the annotation record with the additional annotation data; and
applying the set of state rules to determine a second state of the annotation based on the annotation data in the updated annotation record.

24. The computer-readable medium of claim 21, further comprising notifying an entity of the state of the annotation.

25. The computer-readable medium of claim 24, wherein the entity is responsible for providing annotation data required to change the state of the annotation.

26. An annotation system, comprising:
one or more annotation structures, each identifying one or more annotation fields associated with an annotation type;
an annotation store for storing annotation records, each having fields associated with one of the annotation types;
a set of state rules for each annotation type, wherein each set of state rules defines a plurality of states for each associated annotation type based on the annotation data in the one or more associated fields; and
a state machine configured to access an annotation record and apply the set of state rules for the corresponding annotation type to determine an annotation state based on the date stored therein.

27. The annotation system of claim 26, wherein the system further comprises an executable component for communicating a determined annotation state to an entity.

28. The annotation system of claim 27, wherein the executable component retrieves the annotation state as a field in an annotation record.

29. The annotation system of claim 27, wherein the executable component retrieves the annotation state from the state machine.

30. The annotation system of claim 26, wherein at least one of the state rules associated with one of the annotation types defines an annotation state based on the presence or absence of data in at least one of the associated fields.

31. The annotation system of claim 26, wherein at least one of the state rules associated with one of the annotation types defines an annotation state based on the presence or absence of a text string in at least one of the associated fields.
